(19) United States
(12) Patent Application Publication
(10) Pub. No.: US 2005/0015626 A1
(43) Pub. Date: Jan. 20, 2005

(54) System and method for identifying and filtering junk e-mail messages or spam based on URL content

(76) Inventor: C. Scott Chasin, Denver, CO (US)

Correspondence Address: HOGAN & HARTSON LLP, ONE TABOR CENTER, SUITE 1500, 1200 SEVENTEENTH ST, DENVER, CO, 80202, US

(21) Appl. No.: 10/888,370

(22) Filed: Jul. 9, 2004

Related U.S. Application Data
(60) Provisional application No. 60/487,400, filed on Jul. 15, 2003.

(51) Int. Cl. H04L 9/00

(52) U.S. Cl. 713/201

(57) ABSTRACT

A method for identifying e-mail messages as being unwanted junk or spam. The method includes receiving an e-mail message and then identifying contact and link data, such as URL information, within the content of the received e-mail message. A blacklist including contact information and/or link information previously associated with spam is accessed, and the e-mail message is determined to be spam or to likely be spam based on the contents of the blacklist. The contact or link data from the received e-mail is compared to similar information in the blacklist to find a match, such as by comparing URL information from e-mail content with URLs found previously in spam. If a match is not identified, the URL information from the e-mail message is processed to classify the URL as spam or “bad.” The content indicated by the URL information is accessed and spam classifiers or statistical tools are applied.

### CROSS-REFERENCE TO RELATED APPLICATIONS

This application claims the benefit of U.S. Provisional Application No. 60/487,400, filed Jul. 15, 2003, which is incorporated herein by reference in its entirety.

### BACKGROUND OF THE INVENTION

1. Field of the Invention

The present invention relates, in general, to network security systems such as firewalls and filters or other devices used in such systems for identifying and filtering unwanted e-mail messages or “spam” and, more particularly, to a method and system for using particular message content, such as a Uniform Resource Locator (URL), telephone numbers, and other message content, rather than words, phrases, or tokens to identify and filter or otherwise manage transmittal and/or receipt of e-mail messages in a networked computer system.

2. Relevant Background

The use of the Internet and other digital communication networks to exchange information and messages has transformed the way in which people and companies communicate. E-mail, email, or electronic mail is used by nearly every user of a computer or other electronic device that is connected to a digital communication network, such as the Internet, to transmit and receive messages, i.e., e-mail messages. While transforming communications, the use of e-mail has also created its own set of issues and problems that must be addressed by the information technology and communications industries to encourage the continued expansion of e-mail and other digital messaging.

One problem associated with e-mail is the transmittal of unsolicited and, typically, unwanted e-mail messages by companies marketing products and services, which a recipient or addressee of the message must first determine is unwanted and then delete. The volume of unwanted junk e-mail message or “spam” transmitted by marketing companies and others is increasing rapidly with research groups estimating that spam is increasing at a rate of twenty percent per month. Spam is anticipated to cost corporations in the United States alone millions of dollars due to lost productivity. As spam volume has grown, numerous methods have been developed and implemented in an attempt to identify and filter or block spam before a targeted recipient or addressee receives it. Anti-spam devices or components are typically built into network firewalls or a Message Transfer Agents (MTAs) and process incoming (and, in some cases, outgoing) e-mail messages before they are received at a recipient e-mail server, which later transmits received e-mail messages to the recipient device or message addressee. Anti-spam devices utilize various methods for classifying or identifying e-mail messages as spam including: domain level blacklists and whitelists, heuristics engines, statistical classification engines, checksum clearinghouses, “honeypots,” and authenticated e-mail. Each of these methods may be used individually or in various combinations.

While providing a significant level of control over spam, existing techniques of identifying e-mail messages as spam often do not provide satisfactory results. Some techniques are unable to accurately identify all spam, and it is undesirable to fail to identify even a small percentage of the vast volume of junk e-mail messages as this can burden employees and other message recipients. On the other hand, some spam classification techniques can inaccurately identify a message as spam, and it is undesirable to falsely identify messages as junk or spam, i.e., to issue false positives, as this can result in important or wanted messages being blocked and lost or quarantined and delayed creating other issues for the sender and receiver of the messages. Hence, there is a need for a method of accurately identifying and filtering unwanted junk e-mail messages or spam that also creates no or few false positives.

As an example of deficiencies in existing spam filters, sender blacklists are implemented by processing incoming e-mail messages to identify the source or sender of the message and then, operating to filter all e-mail messages originating from a source that was previously identified as a spam generator and placed on the list, i.e., the blacklist. Spam generators often defeat blacklists because the spam generators are aware that blacklists are utilized and respond by falsifying the source of their e-mail messages so that the source does not appear on a blacklist. There are also deficiencies in heuristics, rules, and statistical classification engines. Rules or heuristics for identifying junk e-mails or spam based on the informational content of the message, such as words or phrases, are fooled by spam generators when the spam generators intentionally include content that makes the message appear to be a non-spam message and/or exclude content that is used by the rules as indicating spam. Spam generators are able to fool many anti-spam engines because the workings of the engines are public knowledge or can be readily reverse engineered to determine what words, phrases, or other informational content is used to classify a message as spam or, in contrast, as not spam.

Because the spam generators are continuously creating techniques for beating existing spam filters and spam classification engines, there is a need for a tool that is more difficult to fool and is effective over longer periods of time at detecting and classifying unwanted electronic messages. More particularly, it is desirable to provide a method, and corresponding systems and network components, for identifying e-mail messages as unwanted junk or spam that addresses the deficiencies of existing spam filters and classification engines. The new method preferably would be adapted for use with existing network security systems and/or e-mail servers and for complimentary use with existing spam filters and classification engines to enhance the overall results achieved by a spam control system.

### SUMMARY OF THE INVENTION

Generally, the present invention addresses the above problems by providing an e-mail handling system and method for parsing and analyzing incoming electronic mail messages by identifying and processing specific message content such as Uniform Resource Locators (URLs), telephone numbers, or other specific content including, but not limited to, contact or link information. URLs, telephone numbers, and/or other contact or link information contained within the message are compared to lists of known offending URLs, telephone numbers, and/or contact or link information that have been identified as previously used within junk e-mail or “spam.”

According to one aspect, the method, and corresponding system, of the present invention provides enhanced blocking of junk e-mail. To this end, the method includes ascertaining if the contents of a message contain a Uniform Resource Locator (URL) (i.e., a string expression representing an address or resource on the Internet or local network) and/or, in some embodiments, other links to content or data not presented in the message itself (such as a telephone number or other contact information such as an address or the like). Based upon that determination, certain user-assignable and computable confidence ratios are automatically determined depending on the address structure and data elements contained within the URL (or other link or contact information). Additionally, if the URL or other link or contact information is identified as being on a list of URLs and other contact or link information that have previously been discovered within junk e-mail, the newly received e-mail message can be assigned a presumptive classification as spam or junk e-mail and then filtered, blocked, or otherwise handled as other spam messages are handled. By applying filters in addition to the contact or link processor to the e-mail message, the confidence ratio used for classifying a message as spam or junk can be increased to a relatively high value, e.g., approaching 100 percent. The mail message can then be handled in accordance with standard rules-based procedures, thus providing a range of post-spam classification disposition alternatives that include denial, pass-through, and storage in a manner determinable by the user.

According to a more specific aspect of the invention, the system and method also advantageously utilize a cooperative tool, known as a “URL Processor,” to determine if a received e-mail message is junk or spam. The e-mail handling system incorporating the method either automatically or as part of operation of an e-mail filter contacts the URL Authenticator or Processor with the URL information identified within the message content. If the URL in the message, such as in the message body, has been identified previously from messages received by other users or message recipients who have received the same or similar e-mails or from a previously compiled database or list of “offending” URLs, the message may be identified as spam or potentially spam. The URL Processor informs an e-mail handling system that asks or sends a query that the received e-mail is very likely junk e-mail. This information from the URL Processor along with other factors can then be weighed by the e-mail handling system to calculate or provide an overall confidence rating of the message as spam or junk.

According to another aspect of the invention, the e-mail handling system and method of the invention further utilize a web searching mechanism to consistently connect to and verify contents of each identified offending URL in an “offending” URL database or list. Data presented at the location of the offending URL is used in conjunction with statistical filtering or other spam identification or classification techniques to determine the URL's content category or associated relation to the junk e-mail. When a message is received that contains a previously known offending URL, the system and method increases a confidence factor that the electronic message containing the URL is junk e-mail. In an alternative embodiment, the system and method of the present invention provides cooperative filtering by sending the resulting probability or response for the offending URL to other filtering systems for use in further determinations of whether the message is junk e-mail.

More particularly, a computer-based method is provided for identifying e-mail messages transmitted over a digital communications network, such as the Internet, as being unwanted junk e-mail or spam. The method includes receiving an e-mail message and then identifying contact data and/or link data, such as URL information, within the content of the received e-mail message. A blacklist is then accessed that comprises contact information and/or link information that was associated with previously-identified spam. The received e-mail message is then determined to be spam or to have a particular likelihood of being spam based on the accessing of the blacklist. The accessing typically comprises comparing the contact/link data from the received e-mail to similar information in the blacklist to find a match, such as comparing a portion of URL information from e-mail content with URLs found previously in spam messages. If a match is found then the message is likely to also be spam. If a match is not identified, further processing may occur such as processing URL information from the e-mail message to classify the URL as spam or “bad.” The additional processing may also include accessing the content indicated or linked by the URL information, such as with a web crawler mechanism, and then applying one or more spam classifiers or statistical tools typically used for processing content of e-mail messages, and then classifying the URL and the corresponding message as spam based on the linked content's spam classification.

### BRIEF DESCRIPTION OF THE DRAWINGS

FIG. 1 illustrates in simplified block diagram form a network incorporating an e-mail handling system according to the invention that utilizes components for identifying unwanted junk e-mail messages or spam in received e-mail messages based on URL or other contact/link data in the message;

FIG. 2 illustrates generally portions of a typical e-mail message that may be processed by the e-mail handling system of the present invention, such as the system and components of FIG. 1;

FIG. 3 illustrates a process for controlling e-mail messages according to the present invention based on contact/link information in the messages such as may be performed by the e-mail handling system of FIG. 1;

FIG. 4 illustrates a process for creating a URL blacklist process according to the present invention that may be utilized by the e-mail handling system of FIG. 1 to identify spam; and

FIG. 5 illustrates a process for grooming or maintaining a URL blacklist, such as might be performed by several of the components of the e-mail handling system of FIG. 1.

### DETAILED DESCRIPTION OF THE PREFERRED EMBODIMENTS

The present invention is directed to a new method, and computer-based systems incorporating such a method, for more effectively identifying and then filtering spam or unwanted junk e-mail messages. It may be useful before providing a detailed description of the method to discuss briefly features of the invention that distinguish the method of the invention from other spam classification systems and filters and allow the method to address the problems these devices have experienced in identifying spam. A spam identification method according to the invention can be thought of as being a method of identifying e-mail messages based on “bad” URLs or other contact information contained within the message rather than only on the content or data in the message itself.

Spam generators are in the business of making money by selling products, information, and services and in this regard, most spam include a link (i.e., a URL) to a particular web page or resource on the Internet and/or other data communication networks or include other contact information such as a telephone number, a physical mailing address, or the like. While spam generators can readily alter their message content to spoof spam classifiers tied only to words or general data in a message's content, it is very difficult for the generators to avoid the use of a link or URL to the page or network resource that is used to make the sales pitch behind the spam message (i.e., the generator's content or targeted URL page content) or to avoid use of some other contact information that directs the message recipient to the sender or sponsor of the unwanted message. Hence, one feature of the inventive method is creation of a blacklist of “bad” URLs and/or other contact or link information that can be used for identifying later-received messages by finding a URL (or other contact or link information), querying the URL blacklist, and then based on the query, classifying the received message containing the URL as spam or ham.

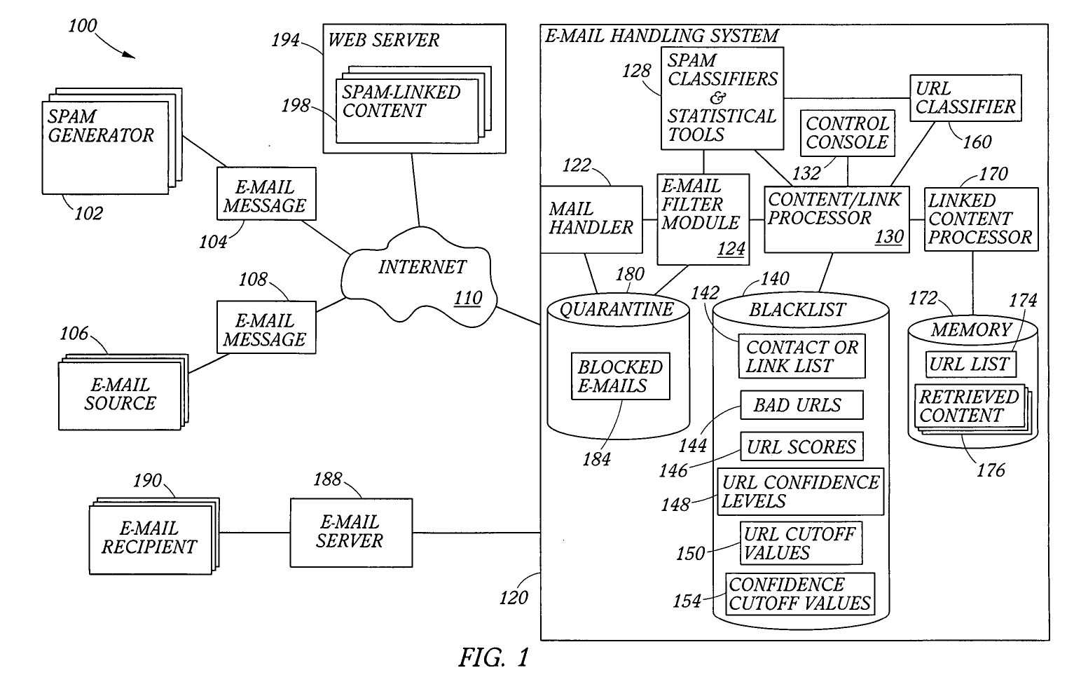

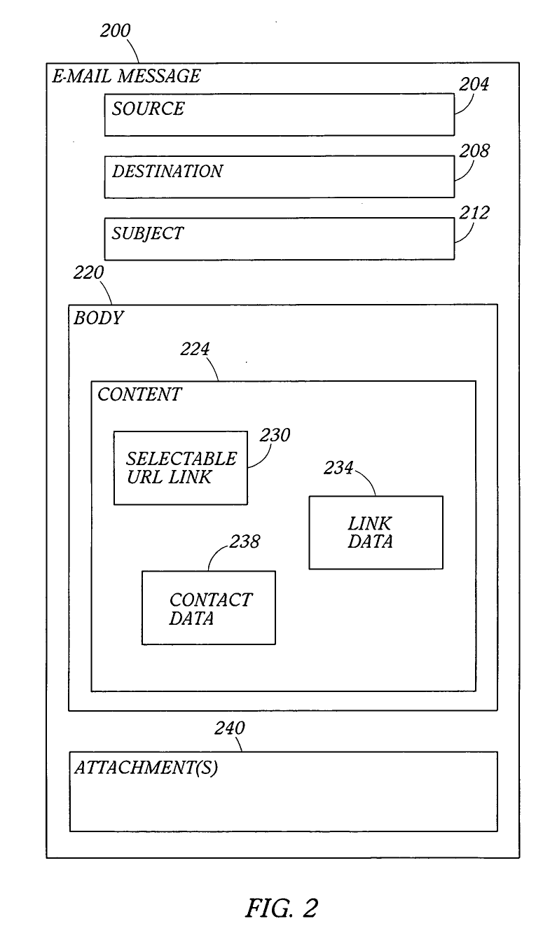

FIG. 1 illustrates one embodiment of a communication system 100 including an e-mail handling system 120 of the present invention. In the following discussion, computer and network devices, such as the software and hardware devices within the systems 100 and 120, are described in relation to their function rather than as being limited to particular electronic devices and computer architectures and programming languages. To practice the invention, the computer and network devices may be any devices useful for providing the described functions, including well-known data processing and communication devices and systems, such as application, database, web, and e-mail servers, mainframes, personal computers and computing devices including mobile computing and electronic devices (particularly, devices configured with web browsers and applications for creating, transmitting, and receiving e-mail messages such as the message shown in FIG. 2) with processing, memory, and input/output components and running code or programs in any useful programming language. Server devices are configured to maintain and then transmit digital data, such as e-mail messages, over a wired or wireless communications network.

Data, including transmissions to and from the elements of the system 100 and among other components of the system 100, typically is communicated in digital format following standard communication and transfer protocols, such as TCP/IP (including Simple Mail Transfer Protocol (SMTP) for sending e-mail between servers), HTTP, HTTPS, FTP, and the like, or IP or non-IP wireless communication protocols such as TCP/IP, TL/PDC-P, and the like. The invention utilizes computer code and software applications to implement many of the functions of the e-mail handling system 120 and nearly any programming language may be used to implement the software tools and mechanisms of the invention. Further, the e-mail handling system 120 may be implemented within a single computer network or computer system or as shown in FIG. 1 or with a plurality of separate systems or network devices linked by one or more communication networks, e.g., one or more of the spam classifiers and statistical tools 128, the contact/link processor 130, the blacklist 140, the URL classifier 160, the linked content processor 170, and memory 172 that can be thought of as “the e-mail identification system” may be provided by a separate computer device or network of devices that are accessible by the e-mail handling system 120 (such as may be the case if the e-mail identification system is accessible on a subscription basis by a one or more e-mail handling systems).

Referring again to FIG. 1, the system 100 includes an e-mail handling system 120 connected to a communication network 110, e.g., the Internet (as shown), a local or wide area network, or the like. The e-mail handling system 120 provides the functions of identifying e-mail messages as unwanted junk or spam based on contact and/or link data or information within the messages as is explained in detail with reference to FIGS. 2-5. Initially, the components of the system 100 are described with only a brief discussion of their functions, which is supplemented in later paragraphs with reference to FIGS. 2-5.

The communication system 100 includes one or more spam generators 102 connected to the Internet 110 that function to transmit e-mail messages 104 to e-mail recipients 190. The e-mail messages 104 are unsolicited and, typically, unwanted by e-mail recipients 190, which are typically network devices that include software for opening and displaying e-mail messages and often, a web browser for accessing information via the Internet 110. The system 100 also includes one or more e-mail sources 106 that create and transmit solicited or at least “non-spam” e-mail messages 108 over the Internet 110 to recipients 190. The spam generators 102 and e-mail sources 106 typically are single computer devices or computer networks that include e-mail applications for creating and transmitting e-mail messages 104, 108. The spam generators 102 are typically businesses that operate to market products or services by mass mailing to recipients 190 while e-mail sources 106 typically include individual computer or network devices with e-mail applications but that are operated by individuals attempting to provide solicited or acceptable communications to the e-mail recipients 190, e.g., non-spam messages which may vary depending on the definition of spam which may vary by system 100, by e-mail server 188, and/or by e-mail recipient 190. As will become clear, the e-mail handling system 120 is adapted to distinguish between the spam and non-spam messages 104, 108 based, at least in part, on particular portions of the content of the messages 104, 108.

Because the e-mail messages 104 are attempting to sell a product or service, the e-mail messages 104 often include contact/link information such as a URL that directs an e-mail recipient 190 or reader of the e-mail message 104 to the provider of the service or product. In many cases, information on the product or service is made available within the communication system 100 and a recipient 190 simply has to select a link (such as a URL) in the message 104 or enter link information in their web browser to access spam-linked information 198 provided by server 194, which is connected to the Internet 110. Alternatively, contact information such as a mailing address, a telephone number, or the like is provided in the message 104 so that an operator of the e-mail recipient devices 190 can contact the sponsor of the spam 104.

FIG. 2 illustrates in simplified fashion a typical e-mail message 200 that may be generated by the spam generator 102 and e-mail source 106. The e-mail message 200 is shown to have several sections or fields. A source field 204 includes information on the origin or source of the e-mail message that can be used to identify the e-mail message 200 as originating from the spam generator 102 or e-mail source 106. However, it is fairly easy for information in the source field 204 to be falsified or altered to disguise the origin or source of the e-mail 200. A destination field 208 is included that provides the e-mail address of the e-mail recipient 190. A subject field 212 is used to provide a brief description of the subject matter for the message 200. Message 200 may include one or more attachment, such as a text or graphic file, in the attachment field or portion 240.

The body 220 of the message 200 includes the content 224 of the message, such as a text message. Significant to the present invention, within the content 224 of the body 220, the message 200 often may include other contact and/or link information that is useful for informing the reader of the message 200 how to contact the generator or sponsor of the message 200 or for linking the reader upon selection of a link directly to a web page or content presented by a server via the Internet or other network 110 (such as spam-linked content 198 provided by web server 194 typically via one or more web pages). In this regard, the content 224 is shown to include a selectable URL link 230 that when selected takes the e-mail recipient 190 or its web browser to the spam-linked content 198 located with the URL information corresponding to the URL link 230.

A URL is a Uniform Resource Locator that is an accepted label for an Internet or network address. A URL is a string expression that can represent any resource on the Internet or local TCP/IP system which has a standard convention of: protocol (e.g., http)://host's name (e.g., 111.88.33.218 or, more typically, www.spamsponsor.com)/folder or directory on host/name of file or document (e.g., salespitch.html). It should be noted, however, that not all e-mail messages 200 that include a URL link 230 are spam with many messages 200 including selectable URL links 230 that do not lead to spam-linked content 198, as it is increasingly common for e-mail sources 106 to pass non-spam messages 108 that include links to web resources (not shown in FIG. 1). Hence, the e-mail handling system 120 is adapted for processing the URL in the link 230 to determine if the message 200 containing the link 230 is likely to be spam.

The content 224 may also include link data 234 which provides network addresses such as a URL in a form that is not directly selectable, and this data 234 may also be used by the e-mail handling system 120 to identify a message 200 as spam. Additionally, messages 200 typically include contact data 238, such as names, physical mailing addresses, telephone numbers, and the like, that allow a reader of the message 200 to contact the sender or sponsor of the message 200. The information in the contact data 238 can also be used by the e-mail handling system 120 to identify which messages 200 are likely to be spam, e.g., by matching the company name, the mailing address, and/or the telephone number to a listing of spam sponsors or similar contact information found in previously identified spam messages.

Referring again to FIG. 1, the e-mail handling system 120 is positioned between the Internet 110 and the e-mail server or destination server 188 and the e-mail recipients 190. The e-mail handling system 120 functions to accept inbound e-mail traffic destined for the e-mail server 188 and recipients 190, to analyze the e-mail messages 104, 108 to determine which messages should be filtered based on spam identifications or other filtering policies (such as attachment criteria, access criteria, and the like), to filter select messages, and to allow unfiltered e-mails (and e-mails released from quarantine 180) to pass to the e-mail server 188 for later delivery to or picking up by the e-mail recipients 190. To this end, the e-mail handling system 120 includes an e-mail handler 122 that acts to receive or accept e-mail messages 104, 108 destined for the recipients 190. The handler 122 may take any useful form for accepting and otherwise handling e-mail messages, and in one embodiment, comprises a message transfer agent (MTA) that creates a proxy gateway for inbound e-mail to the e-mail server or destination mail host 188 by accepting the incoming messages with the Simple Mail Transport Protocol (SMTP), e.g., is a SMTP proxy server. In this embodiment, the handler 122 acts to open a connection to the destination e-mail server 188. During operation, the handler 122 passes the e-mail messages 104, 108 through the e-mail filter modules 124 and contact/link processor 130 prior to streaming the messages to the e-mail server (e.g., destination SMTP server).

The e-mail handling system 120 includes one or more e-mail filter modules 124 for parsing the received e-mail messages and for filtering messages based default and user-specified policies. Filtered messages may be blocked or refused by the filter modules 124, may be allowed to pass to the recipient 190 with or without tagging with information from the filtering modules 124, and/or may be stored in a quarantine as blocked e-mails 184 (or copies may be stored for later delivery or processing such as by the contact/link processor 130 to obtain URLs and other contact information). The modules 124 may include spam, virus, attachment, content, and other filters and may provide typical security policies often implemented in standard firewalls or a separate firewall may be added to the system 100 or system 120 to provide such functions. If included, the spam filters in the modules 124 function by using one or more of the spam classifiers and statistical tools 128 that are adapted for individually or in combination identifying e-mail messages as spam.

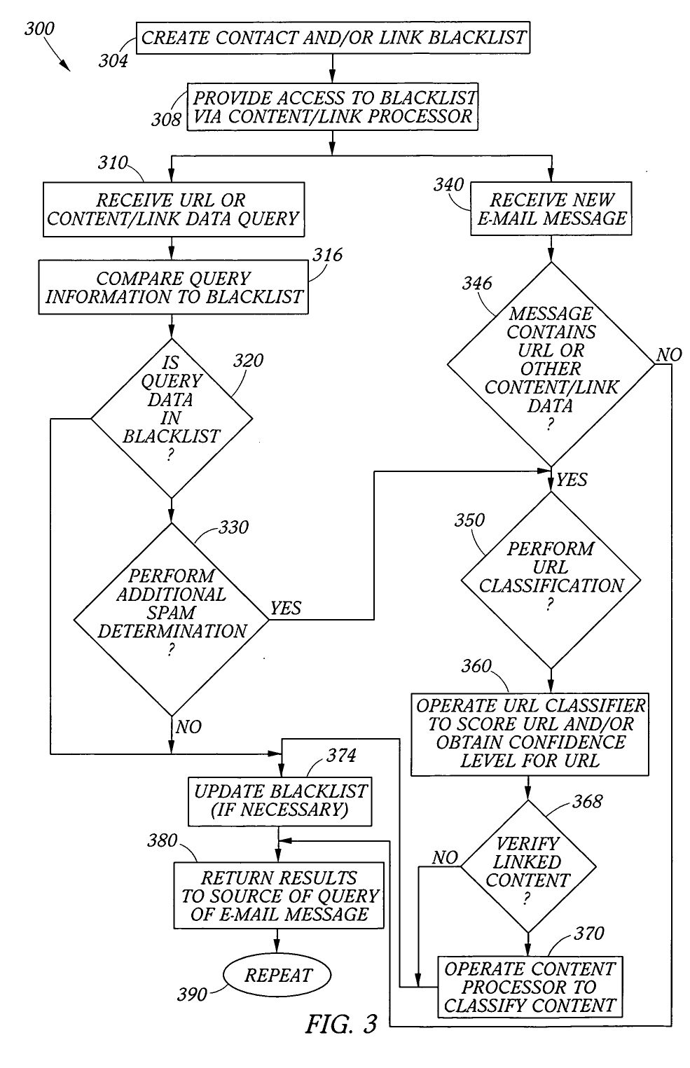

As is explained below with reference to FIGS. 3-5, the classifiers or classification tools 128 implemented by the filter modules 124 may be used as additional filters for increasing the confidence factor for an e-mail message 104 containing a URL identified as potentially leading to spam or junk content 198 (e.g., indicating that the message containing the URL is itself spam that should be filtered or otherwise handled as a junk message). Further, in some embodiments, the classifiers and statistical tools 128 are also utilized in various combinations (one or more classifier used alone or in combination with or without a statistical technique) by the contact/link processor 130, URL classifier 160, and/or the linked content processor 170 for analyzing data that is provided at the end of a link (such as a URL) in a message or the URL itself. However, it should be noted that other classifiers not described in this description (or even developed yet) might be used with those discussed or separately to practice the invention, as the use of particular classifiers is not a limitation of the invention.

In some embodiments of the invention, the spam classifiers and statistical tools 128 may be used by the modules 124 and e-mail identification components 130, 160, 170 by combining or stacking the classifiers to achieve an improved effectiveness in e-mail classification and may use an intelligent voting mechanism or module for combining the product or result of each of the classifiers. The invention is designed for use with newly-developed classifiers and statistical methods 128 which may be plugged into the system 120 for improving classifying or identifying spam, which is useful because such classifiers and methods are continually being developed to fight new spam techniques and content and are expected to keep changing in the future.

The following is a brief description of spam classifiers and tools 128 that may be used in some embodiments of the invention but, again, the invention is not limited to particular methods of performing analysis of spam. The classifiers and tools 128 may use domain level blacklists and whitelists to identify and block spam. With these classifiers 128, a blacklist (not shown in FIG. 1) is provided containing e-mail addresses of spam generators 102 and e-mail messages 104, 108 having addresses in the list in the source field 204 are denied or filtered by the modules 124. Alternatively, whitelists include e-mail addresses of senders or sources (such as sources 106) for which e-mail is always accepted. Distributed blacklists take domain blacklists to a higher level by operating at the network level. Distributed blacklists catalog known spammer 102 addresses and domains and make these catalogs available via the Internet 110.

The classifiers and tools 128 may also include heuristic engines of varying configuration for classifying spam in messages received by handler 122. Heuristic engines basically implement rules-of-thumb techniques and are human-engineered rules by which a program (such as modules 124) analyzes an e-mail message for spam-like characteristics. For example, a rule might look for multiple uses in the subject 212, content 224, and/or attachments 240 of a word or phrase such as “Get Rich”, “Free”, and the like. A good heuristics engine 128 incorporates hundreds or even thousands of these rules to try to catch spam. In some cases, these rules may have scores or point values that are added up every time one rule detects a spam-like characteristic, and the engine 128 or filter 124 implementing the engine 128 operates on the basis of a scoring system with a higher score being associated with a message having content that matches more rules.

The classifiers and tools 128 may include statistical classification engines, which may take many different forms. A common form is labeled “Bayesian filtering.” As with heuristics engines, statistical classification methods like Bayesian spam filtering analyze the content 224 (or header information) of the message 200. Statistical techniques however assess the probability that a given e-mail is spam based on how often certain elements or “tokens” within the e-mail have appeared in other messages determined to have been spam. To make the determination, these engines 128 compare a large body of spam e-mail messages with legitimate or non-spam messages for chunks of text or tokens. Some tokens, e.g., “Get Rich”, appear almost only in spam, and thus, based on the prior appearance of certain tokens in spam, statistical classifiers 128 determine the probability that a new e-mail message received by the handler 122 with identified tokens is spam or not spam. Statistical spam classifiers 128 can be accurate as they learn the techniques of spam generators as more and more e-mails are identified as spam, which increases the body or corpus of spam to be used in token identification and probability calculations. The classifiers and tools 128 may further include distributed checksum clearinghouses (DCCs) that use a checksum or fingerprint of the incoming e-mail message and compare it with a database of checksums of to identify bulk mailings. Honeypots may be used, too, that classify spam by using dummy e-mail addresses or fake recipients 190 to attract spam. Additionally, peer-to-peer networks can be used in the tools 128 and involve recipients 190 utilizing a plug in to their e-mail application that deletes received spam and reports it to the network or monitoring tool 128. Authenticated mail may also be used and the tools 128 may include an-authentication mechanism for challenging received e-mails, e.g., requesting the sender to respond to a challenge before the message is accepted as not spam.

The filter modules 124 may be adapted to combine two or more of the classifiers and/or tools 128 to identify spam. In one embodiment, a stacked classification framework is utilized that incorporates domain level blacklists and whitelists, distributed blacklists, a heuristics engine, Bayesian statistical classification, and a distributed checksum clearinghouse in the classifiers and tools 128. This embodiment is adapted so that the filters 124 act to allow each of these classifiers and tools 128 to separately assess and then “vote” on whether or not a given e-mail is spam. By allowing the filter modules to reach a consensus on a particular e-mail message, the modules 124 work together to provide a more powerful and accurate e-mail filter mechanism. E-mail identified as spam is then either blocked, blocked and copied as blocked e-mails 184 in quarantine 180, or allowed to pass to e-mail server 188 with or without a tag identifying it as potential spam or providing other information from the filter modules 124 (and in some cases, the operator of the system 120 can provide deposition actions to be taken upon identification of spam). Because even the combined use of multiple classifiers and tools 128 by the filter modules 124 may result in e-mail messages not being correctly identified as spam even when the messages 104 originate from a spam generator 102, the e-mail handling system 120 includes additional components for identifying spam using different and unique techniques.

According to an important feature of the invention, the e-mail handling system 120 includes a contact/link processor 130 that functions to further analyze the received e-mail messages to identify unwanted junk messages or spam. In some embodiments, the handling system 120 does not include the e-mail filter modules 124 (or at least, not the spam filters) and only uses the processor 130 to classify e-mail as spam. The contact/link processor 130 acts to process e-mail messages to identify the message as spam based on particular content in the message, and more particularly, based on link data, URLs, and/or contact data, such as in the content 224 or elsewhere in the message 200 of FIG. 2.

Operation of the contact/link process 130 and other components of the e-mail identification system, i.e., the blacklist database 140, the URL classifier 160, and the linked content processor 170, are described below in detail with reference to FIGS. 3-5. However, briefly, the contact/link process 130 which may comprise a URL authenticator or processor, functions to analyze the contact and/or link content of at least a portion of the e-mails received by the handler 122. With reference to FIG. 2, the processor 130 acts to parse the message 200 to identify any selectable URL links 230, link data 234, and contact data 238. To this end, the processor 130 accesses the blacklist 140 shown as part of the system 120 but it may be located in a separate system (not shown) that is accessible by the processor 130. The processor 130 compares the parsed contact and link data to URLs on the bad URL list 144 and to contact/link data on the contact or link list 142. These lists contain URLs found in previously identified spam or that have been identified as “bad” URLs or URLs that lead to spam or spam-like content 198. When matches are identified by the processor 130, the e-mail message is identified as spam and the processor 130 (or another device in the system 120) performs deposition actions assigned by an administrator of the system or default actions including blocking the e-mail, copying the e-mail to quarantine 180 as blocked e-mails 184, and/or passing the e-mail to the e-mail server 188 (e.g., doing nothing or tagging the message such as with a note in the subject).

URL scores 146 stored with the bad URLs 144 are typically assigned by the URL classifier 160, which applies the classifiers and tools 128 or other techniques to classify the URL link or URL data as spam-like. In other words, the URL classifier processes the content of the URL itself to determine whether it is likely that the message providing the URL link 230 originated from a spam generator 102 or leads to spam-linked content 198. In contrast, the URL confidence levels 148 are assigned by the contact/link processor 130 by using one or more of the classifiers or tools 128 to analyze the content of the message including the URL. In other embodiments, one or more of the filter modules 124 may provide the confidence level 148 as a preprocessing step such as with the message being passed to the processor 130 from the filter modules 124 with a spam confidence level based on the content 224 of the message 200.

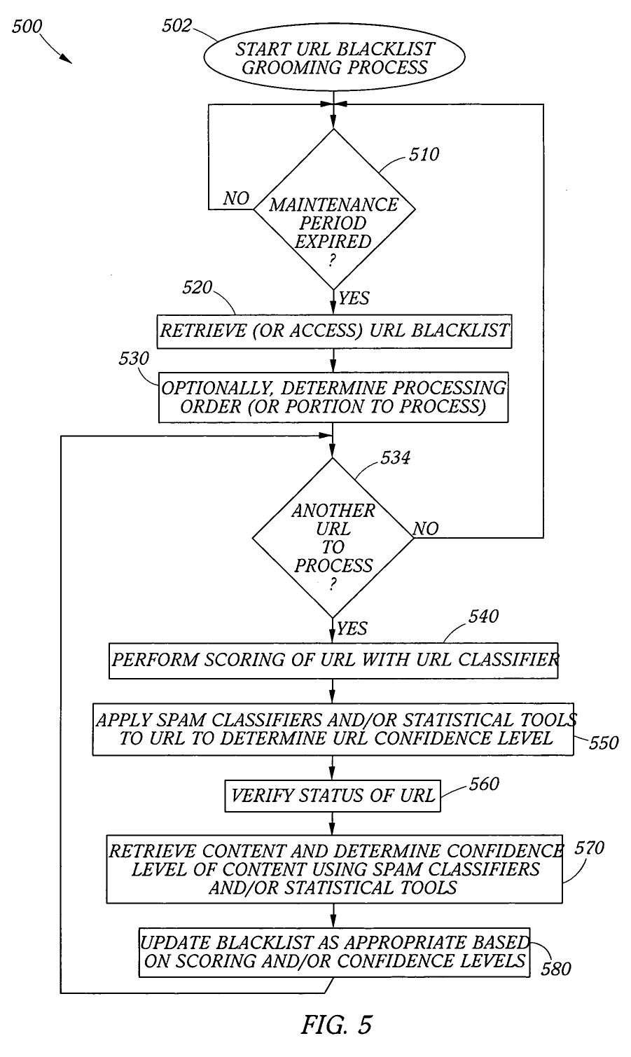

The URL confidence levels 148 may also be determined by using the linked content processor 170 to analyze the content found at the URL parsed from the message by the processor 130. The linked content processor 170 may comprise a web crawler mechanism for following the URL to the spam-linked content 198 presented by the web server 194 (or non-spam content, not shown). The processor 170 then uses one or more of the spam classifiers and statistical tools 128 (or its own classifiers or algorithms) to classify the content or resources linked by the URL as spam with a confidence level (such as a percentage). The memory 172 is provided for storing a copy of URLs found in messages determined to be spam or a copy of the bad URL list 144 and retrieved content (such as content 198) found by visiting the URLs in list 174, such as during maintenance of the blacklist 140 as explained with reference to FIG. 5. In making the spam identification decision, the contact/link processor 130 may compare the URL scores 146 and/or the URL confidence levels 148 to URL cutoff values or set points 150 and confidence cutoff values or set points 154 that may be set by a system administrator or by administrators of the e-mail server 188.

The setting of the values 150, 154 and certain other functions of the system 120 that are discussed below as being manual or optionally manual may be achieved via the control console 132 (such as a user interface provided on a client device such as a personal computer) with an administrator entering values, making final spam determinations, accepting recommended changes to the blacklist 140, and the like. For messages determined not to be spam or to be spam but having a pass-through deposition action, the processor 130 functions to pass the message to the e-mail server 188 for eventual delivery to or pick up by the e-mail recipients 190.

With this general understanding of the components of the communication system 100 and more particularly, of the e-mail handling system 120 understood, a detailed discussion of the operation of the e-mail handling system 120 is provided in creating a blacklist, such as blacklist 140. Operation of the system 120 is also described for responding to queries from e-mail handling systems subscribing to the blacklist with spam identifications or as shown in FIG. 2, and the operation of the components in the e-mail handling system 120 are described that provide identification of spam based on contact/link data such as URLs in messages.

With reference to FIG. 3 as well as FIGS. 1 and 2, a method for identifying and filtering spam (or controlling incoming e-mail messages) 300 is illustrated that begins with the creation at 304 of a contact and/or link blacklist. A key feature of the invention is the initial creation of the blacklist, such as blacklist 140, that is based on identifying contact/link data in messages that can be used to identify later processed e-mail to determine a likelihood the message is spam. For example, the bad URL list 144 is a database or other listing of identified URLs and other information (such as scores 146 and confidence levels 148) that are useful for comparing with later-identified URLs with the listed URLs to identify likely spam or unwanted messages. The creation of the blacklist 144 can be accomplished in a number of ways that can be performed individually or in varying combinations. For example, to create the contact or link blacklist 142, e-mails that have been identified as being spam by other methods, such as by e-mail filter modules 124 employing spam classifiers and statistical tools 128, are processed (typically manually) to parse or identify contact or link data (such as data 234, 238 in the content 224 of message 200) in the content of a message. For example, blocked e-mails 184 may be processed manually or with automated tools to identify telephone numbers, individual and company contact names, physical mailing addresses, and the like (i.e., contact data 248) that should be added to the contact list 142. Additionally, link data can be extracted from the message content (such as link data 234 that may comprise network addresses of resources or content on the network 110 that is not in selectable URL form) and this can be added to the link list 142.

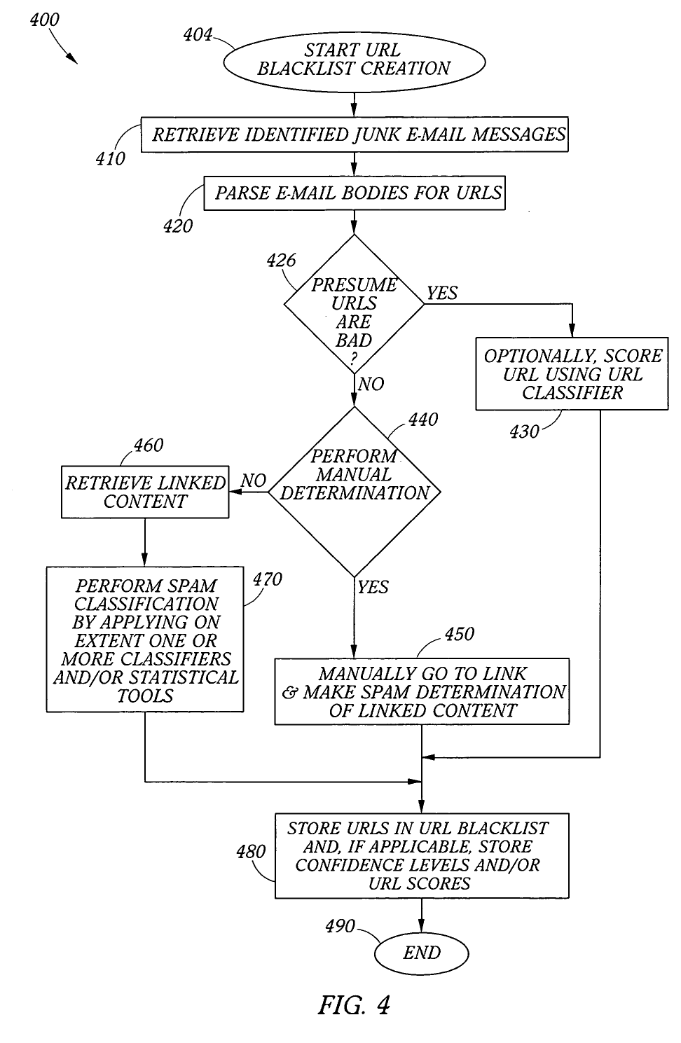

FIG. 4 illustrates an exemplary process 400 for creating a bad URL list or URL blacklist. At 404 the creation 400 is started typically by accessing a store of e-mail messages that have previously been identified as spam such as blocked e-mails 184 and more preferably, a plurality of such stores are accessed to provide a large body or corpus of spam to process and create a larger, more comprehensive URL blacklist 144. At 410, the pool of identified junk e-mails or spam is accessed or retrieved to allow processing of the content of each of the messages, such as content 224 of message 200. At 420, each of the junk or spam e-mail messages is parsed or processed to identify URL or URL content in the content of the message (such as URL link 230 in message 200). At 426, the process 400 involves deciding whether all URLs in the spam messages should be presumed to be “bad”. If so, the URLs are stored at 480 in the URL blacklist, such as list 144 of blacklist 140.

Optionally, prior to such storage, the URLs from the spam may be further processed at 430 to score or rate each URL or otherwise provide an indicator of the likelihood that the URL is bad or provides an unacceptable link, e.g., a link to spam content or unwanted content. In one embodiment, the contact/link processor 130 calls the URL classifier 160 to analyze the content and data within the URL itself to classify the URL as a bad URL, which typically involves providing a score that is stored with the URL at 146 in the blacklist 140. In one embodiment, the URL classifier 160 applies 1 to 20 or more heuristics or rules to the URL from each message with the heuristics or rules being developed around the construction of the address information or URL configurations. For example, the URL classification processing may include the classifier 160 looking at each URL for randomness, which is often found in bad URLs or URL linking to spam content 198. Another heuristic or rule that may be applied by the URL processor is to identify and analyze HTML or other tags in the URL. In one embodiment, HREF tags are processed to look for links that may indicate a bad URL and HTML images or image links are identified that may also indicate a URL leads to spam content or is a bad URL.

In one embodiment, the results of the URL processing by the URL classifier 160 is a URL score (such as a score from 1 to 10 or the like) that indicates how likely it is that the URL is bad (e.g., on a scale from 1 to 10 a score above 5 may indicate that it is more likely the URL is bad). The URL blacklist or database 140 may be updated to include all URLs 144 along with their score 146 or to include only those URLs determined to be bad by the URL processor 130, such as those URLs that meet or exceed a cutoff score 150, which may be set by the administrator via the control console 132 or be a default value.

To more accurately classify URLs as bad, the URL classifier 160 may utilize one or more tools, such as the classifiers and statistical tools 128, that are useful for classifying messages as spam or junk based on the content of the message and not on the URL. These classifiers or filters and statistical algorithms 128 may be used in nearly any combination (such as in a stacked manner described above with reference to FIG. 1 and the modules 124) or alone. Generally, these content-based tools 128 are useful for determining a “confidence” value or level for the e-mail message based on its content, and such confidence is typically expressed as a probability or percentage that indicates how likely it is that the message is spam or junk based on its content. In some embodiments, the URL classifier passes the content of the message (such as content 224 of message 200) to remote tools for determination of the confidence while in other embodiments, the URL processor includes or accesses the content-based tools 128 and determines the confidence itself. In some embodiments, the confidence level is determined as a preprocessing step by the e-mail filter modules 124. The URL database or blacklist 140 may then be updated at 480 of the method 400 by the contact/link processor 130 to include the confidence levels 148 for each listed bad URL 144.

In some cases, the URLs to be included in the list 144 is determined by the processor 130 or classifier 160 based on the confidence level, e.g., if a confidence is below a preset limit 154, the URL may not be listed or may be removed from the list. Then, when the URL processor 130 responds to a URL match request (such as from a subscribing e-mail handling system (not shown in FIG. 1) or by the filter modules 124 of FIG. 1, the processor 130 typically provides the confidence level 148 (optionally with the score 146) to the requestor or in some cases, the processor 130 may use the confidence level of the particular URL from the list 144 to determine whether a “match” should be indicated. For example, in some embodiments, the processor 130 may establish a minimum confidence level (stored element 154) generally or for particular requesting parties for matches (or such a minimum confidence level 154 may be established or provided by the requesting parties to allow the requesting party to set their own acceptability of false positives).

Referring again to FIG. 4, if the URLs are not to be presumed “bad” with or without additional URL-based scoring and/or confidence level analysis, the method 400 continues at 440 where it is determined whether manual spam analysis or identification is to be performed. If yes, the method 400 continues at 450 with a person such as a spam or URL administrator manually going to the link or URL found in the message, i.e., selecting the URL link and the like. The administrator can then access the content (e.g., spam-linked content 198) to determine whether the content linked by the URL is spam or likely to be spam. A set of rules may be applied manually to make this determination. Once the determination has been made, the administrator can manually add the URL to the URL blacklist 480 or create a list of URLs to be later added by the contact/link processor, and typically, such URLs would have no score or confidence level 146, 148 or default ones associated with manual identification of spam content 198 (e.g., all manual identifications may be provided a score of 9 out of 10 with a confidence level of 90 percent or the like).

Alternatively, at 440, it may be determined that automated analysis is to be performed of the resource or content linked to the URL or network address. In this case, the process 400 continues at 460 with the linked content, such as spam-linked content 198, being retrieved and stored for later analysis, such as retrieved content 176. The retrieval may be performed in a variety of ways to practice the invention. In one embodiment, the retrieval is performed by the linked content processor 170 or similar mechanism that employs a web crawler tool (not shown) that automatically follows the link through re-directs and the like to the end or sponsor's content or web page (such as content 198). At 470, the linked content processor 170 analyzes the accessed content or retrieved content 176 to determine whether the content is likely spam. The spam analysis, again, may take numerous forms and in some embodiments, involves the processor 170 using one or more spam classifiers and/or statistical analysis techniques that may be incorporated in the processor 170 or accessible by the processor 170 such as classifiers and tools 128. The content is scored and/or a confidence level is typically determined for the content during the analysis 470. The spam determination at 470 then may include comparing the determined or calculated score and/or confidence level with a user provided or otherwise made available minimum acceptable score or confidence level (such as cutoff values 150, 154) above which the content, and therefore, the corresponding URL or link, is identified as spam or “bad.” For example, a score of 9 out of 10 or higher and/or a confidence level of 90 to 95 percent or higher may be used as the minimum scores and confidence levels to limit the number of false positives. All examined URLs or only URLs that are identified as “bad” are then stored at 480 in the blacklist (such as blacklist 140 at 144) with or without their associated scores and confidence levels (e.g., items 146 and 148 in FIG. 1). The method 400 ends at 490 after all or at least a significant portion of the list of URLs 174 have been processed, e.g., steps 430-480 are repeated as necessary to process the URLs from the junk e-mail messages.

Returning to the e-mail control method 300 of FIG. 3, after the initial blacklist is created or made available, access is provided to the blacklist 140 at 308. Generally, the access is provided to the blacklist 140 via the contact/link processor 130 that is adapted to process users' (such as filter modules 124) or subscribers' queries. In this regard, the method 300 shows two main branches illustrating two exemplary ways in which the blacklist 140 may be used, i.e., as a standalone service to which users subscribe (see functions 310-330 and 350-390) and as part of an e-mail handling system, such as system 120, to process received e-mails directly (see functions 340, 346, and 350-390).

At 310, the processor 130 receives a URL or contact/link data query, such as from a filter module 124 but more typically, from a remote or linked e-mail handling system that is processing a received e-mail message to determine whether the message is spam. The query information may include one or more URLs found in a message (such as URL link 230 in message 200 of FIG. 2) and/or the query information may include one or more sets of link data and/or contact data (such as link data 234 and contact data 238 in content 224 of message 200). At 316, the contact/link processor 130 acts to compare the query information to information in the blacklist 140. Specifically, URLs in the query information are compared to URLs in the bad URL list 144 and contact/link data in the query information is compared to contact/link data in the list 142.

At 320, it is determined whether a match in the blacklist 140 was obtained with the query information. If yes, the method 300 continues with updating the blacklist 140 if necessary. For example, if the query information included contact information and a URL and one of these was matched but not the second, then the information that was not matched would be added to the appropriate list 142, 144 (e.g., if a URL match was obtained but not a telephone number or mailing address then the telephone number or mailing address would be added to the list 142 (or vice versa)). At 380, the contact/link processor 130 returns the results to the requesting party or device and at 390 the process is repeated (at least beginning at 310 or 340). The results or response to the query may be a true/false or yes/no type of answer or may indicate the URL or contact/link information was found in the blacklist 140 and provide a reason for such listing (e.g., the assigned score or confidence factor 146, 148 and in some cases, providing what tools, such as classifiers and tools 128, were used to classify the URL and/or linked content as bad or spam).

The processor 130 may employ a URL or contact/link data authenticator or similar mechanism that comprises a DNS-enabled query engine that provides a true/false result if the give URL or contact/link data is in or not in the database or blacklist 140. Of course, the matching process may be varied to practice the invention. For example, the method of the invention 300 may utilize all or portions of the URL passed in the query or all or part of query information in determining matches. In the case of a URL lookup or match process, the processor 130 may use the locator type, the hostname/IP address, the path, the file, or some combination of these portions of standard URLs.

At 330 the method 300 includes determining whether additional spam analysis or determinations should be performed when a match is not found in the blacklist. For example, the blacklist 140 typically will not include all URLs and contact/link used by spam generators 102, and hence, it is often desirable to further process query information to determine whether the message containing the URL and/or contact/link data is likely spam. In these cases, the method 300 continues at 350 with additional spam identification processing which overlaps with processing performed on newly received e-mail messages in systems that incorporate the processor 130 as a separate element as shown in FIG. 1 or as one of the filter modules 124.

In these embodiments, the method 300 includes receiving a new e-mail message 340, such as at handler 122. At 346, the processor 130 processes the message, such as by parsing the content 224 of the message 200, to determine whether the message contains URL(s) 230 and/or contact/link data 234, 238. If not, the method 300 continues with performance of functions 374, 380, and 390. If such information is found, the method 300 continues at 350 with a determination of whether a URL was found and whether classification of the URL is desired. If yes, the method 300 continues at 360 with the process 130 acting, such as with the operation of a URL classifier 165 described in detail with reference to FIG. 4, to process the URL to determine if the URL itself is likely bad or provides an address of spam content 198. This analysis may involve providing a score or ranking of the URL and/or determining a confidence level for the URL and then comparing the score and/or confidence level to cutoff values 150, 154.

At 368, the method 300 continues with a determination if the linked content is to be verified or analyzed for its spam content. If not (i.e., the prior analysis is considered adequate to identify the URL and/or contact/link data as “bad” or acceptable and the corresponding message as spam or not spam), the method 300 continues with functions 374, 380, and 390. If content analysis is desired, the method 300 continues at 370 with operating the linked content processor 170 to classify the content. This typically involves accessing the page or content (such as content 198) indicated by the URL or link data in the query information or newly received e-mail and applying spam classifiers and/or statistical analysis tools (such as classifiers and tools 128) to the content. Alternately or additionally, the content analysis at 370 may involve analyzing the content, such as content 224 of message 200, in the message containing the URL and/or contact/link data (such as elements 230, 234, 238 of message 200) to determine the likelihood that the message itself is spam. In this manner, the use of the URL and/or contact/link data to identify a message as spam can be thought of as an additional or cumulative test for spam, which increases the accuracy of standard spam classification tools in identifying spam. After completion of 370, the method 300 completes with updating the blacklist 140 as necessary at 374, returning the results to the query or e-mail source and repeating at 390 at least portions of the method 300. The method 300, of course, can include deposing of the e-mail message as indicated by one or more deposition policies for newly received messages (such as discussed with reference to FIG. 1 and components 124, 180, 184, 188).

In addition to responding to URL identification requests, some embodiments of the invention involve maintaining and grooming the bad URL database or list 144 on an ongoing or real-time basis. Grooming or updating may involve an e-mail being received at a mail handler, the e-mail message being parsed to identify any URLs (or other links) in the message content, and providing the URL(s) to a URL processor that functions to identify which URLs are “bad” or lead to spam content. The URL processor may function as described above involving manually or automatically going to the URL to identify the content as spam or junk. More typically, the URL processor will analyze the content and data of the URL itself to classify the URL as a bad URL.

FIG. 5 illustrates one exemplary URL blacklist grooming or maintenance process 500 that starts at 502 typically with providing a contact/link processor 130 with access to a blacklist 140 that includes a listing of bad URLs 144. At 510, the processor 130 determines when a preset maintenance period has expired. For example, it may be useful to nearly continuously groom the blacklist 140 (such as hourly, daily, and the like) or due to processing requirements or other limitations, it may be more desirable to groom the blacklist 140 less frequently such as on a weekly, bi-weekly, monthly, or other longer period of time. When the maintenance period has expired, the method 500 continues at 520 with retrieval of (or accessing the) existing URL list 144 which may be stored in memory 172 as a URL list 174 to be processed or groomed.

In general, the goal of the grooming process 500 is to determine if one or more of the currently listed URLs should be removed from the URL list 144 and/or if the score and/or confidence levels 146, 148 associated with the URL(s) should be modified due to changes in the linked content, changes in identification techniques or tools, or for other reasons. Due to resource restraints, it may be desirable for only portions of the list to be groomed (such as URLs with a lower score or confidence level or URLs that have been found in a larger percentage of received e-mails) or for grooming to be performed in a particular order. In this regard, the method 500 includes an optional process at 530 of determining a processing order for the URL list 174. The processing may be sequential based upon when the URL was identified (e.g., first-in-first-groomed or last-in-first-groomed or the like) or grooming may be done based on some type of priority system, such as the URLs with lower scores or confidence levels being processed first. For example, it may be desirable to process it may desirable to process the URLs from lowest score/confidence level to highest to remove potential false positives or vice versa to further enhance the accuracy of the method and system of the invention. Further, grooming cutoffs or set points may be used to identify portions of the URL list to groom, such as only grooming the URLs below or above a particular score and/or confidence level.

At 534, the method 500 continues with determining if there are additional URLs in the list 174 (or in the portion of the list to be processed). If not, the method 500 returns to 510 to await the expiration of another maintenance period. If yes, at 540, the URLs are scored with the URL classifier 160 (as described with reference to method 400 of FIG. 4). Next, at 550, spam classifiers and/or statistical tools, such as classifiers and tools 128 or other rules and algorithms, are applied by the URL classifier 160 to determine a confidence level of the URL itself. Optionally, one or both of functions 540 and 550 may be omitted or the two functions can be combined.

At 560, the linked content processor 170 is called to process each URL in the list 174 (or a portion of such URLs). As discussed above, the content processor 170 may comprise a web crawler device and is adapted for analyzing the generator content indicated by the URL, such as the content provided on a page at the IP address or content 198 in FIG. 1. The content processor 170 in one embodiment is used as an independent or behind the scenes process that is used to groom or update the bad URL database 144. The content processor 170 is preferably smart enough to not be fooled by redirects, multiple links, or the like and is able to arrive at the end point or data (content 198) represented by the URL. At 560, the content processor 170 verifies the status of the URL, i.e., does it point to an inactive page, and this status can be used for identifying whether a URL is inactive URLs are not generally “bad” as spam generators generally will maintain their pages and content or provide a new link from the stale page. Inactive URLs generally are removed from the blacklist 144 at 580 of method 500.

At 570, the content processor 170 crawls to a web page or resource indicated by the URL in the list 174. Once at the endpoint, the data on the page(s) is gathered and stored at 176 for later processing. The stored data is then analyzed, such as with spam classifiers or filters and/or statistical tools 128 such as Bayesian tools, to determine a confidence level or probability that the content is spam. The confidence obtained by the crawler tool or content processor 170 is then passed to the URL processor (or other tool used to maintain the bad URL list) 130. At 580, the URL processor 130 can then add this confidence 148 and/or score 146 to the database 144 with to the URL as a separate or second confidence (in addition to a confidence provided by analysis of the message content by other classifiers/statistical tools). Alternatively, the crawler content processor confidence may replace existing confidences and/or scores or be used to modify the existing confidence (e.g., be combined with the existing confidence). The updating at 580 may also include comparing new scores and confidence levels with current cutoffs 150, 154 and when a URL is determined to not be bad removing the URL from the list 144. Inactive URLs may also be removed from the list 144 at 580.

The “grooming” or parts of the grooming 500 of the bad URL database 144 may be controlled manually to provide a control point for the method 500 (e.g., to protect the database information and integrity). For example, the crawler content processor 170 may provide an indicator (such as a confidence level) that indicates that a web page is not “spammy” and should, therefore, be deleted from the list. However, the actual deletion (grooming) from the list may be performed manually at 580 to provide a check in the grooming process to reduce the chances that URLs would be deleted (or added in other situations) inaccurately.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. For example, the e-mail identification portion of the e-mail handling system 120 may be provided in an e-mail handling system without the use of the e-mail filter modules 124, which are not required to practice the present invention. Further, the e-mail identification portion, e.g., the contact/link processor 130, blacklist 140 and/or other interconnected components, may be provided as a separate service that is accessed by one or more of the e-mail handling systems 120 to obtain a specific service, such as to determine whether a particular URL or contact/link data is on the blacklist 140 which would indicate a message is spam.

1. A method for identifying e-mail messages received over a digital communications network as unwanted junk e-mail or spam, comprising:
receiving an e-mail message;
identifying at least one of contact data and link data within content of the received e-mail message;
accessing a blacklist comprising at least one of contact information and link information associated with previously-identified spam; and
determining whether the received e-mail message is spam based on the accessing.

2. The method of claim 1, wherein the link data comprises Uniform Resource Locator (URL) information and the link information in the blacklist comprises URL information retrieved from the previously-identified spam.

3. The method of claim 2, wherein the accessing comprises comparing at least a portion of the URL information from the received e-mail message with the URL information in the blacklist to identify a match and wherein the received e-mail message is identified as spam in the determining based on the identified match.

4. The method of claim 2, further comprising determining in the accessing that the URL information in the received message is not in the URL information in the blacklist and then, processing the URL information in the received message to determine whether the received message is spam.

5. The method of claim 4, further comprising processing content in the received message by applying a spam classifier or spam statistical tool to create a confidence level associated with spam for the content of the received message.

6. The method of claim 2, further comprising accessing content linked by the URL information in the received message, processing the linked content to determine whether the linked content is spam, and reporting the results of the processing of the linked content for use in the spam determining.

7. The method of claim 1, wherein contact data comprises a telephone number, an e-mail address, a physical mailing address, or a name.

8. A computer-based method for identifying e-mail messages as spam based on Uniform Resource Locators (URLs) within the content of the messages, comprising:
providing a list of URLs determined to be related to unwanted e-mail messages or spam sponsored content;
receiving a query associated with an e-mail message, the query comprising URL information;
comparing at least a portion of the URL information in the query to the list of URLs; and
reporting a result of the comparing for use in identifying the e-mail message as spam.

9. The method of claim 8, wherein the result comprises a URL score or a content confidence level.

10. The method of claim 8, wherein the comparing determines the URL information is not in the list of URLs and further comprising performing additional spam processing comprising analyzing the URL information to classify the URL information in the e-mail message based on a likelihood that the URL information is linked to spam content.

11. The method of claim 8, wherein the comparing determines the URL information is not in the list of URLs, and further comprising processing content accessible with the URL information to determine whether the URL-linked content is spam, the reporting including the determination of the processing in the reported result.

12. A method for providing a set of Uniform Resource Locators (URLs) for use in determining whether a received e-mail message is unwanted junk or spam, comprising:
accessing a plurality of e-mail messages identified as spam;
processing content of the e-mail messages to identify one or more URLs;
determining whether the identified URLs are spam-related; and
in memory, storing a bad URL file comprising the URLs determined to be spam-related.

13. The method of claim 12, further comprising providing access to the bad URL file to a system receiving e-mail messages.

14. The method of claim 12, wherein the determining comprises accessing content linked by the identified URLs and performing a spam classification of the linked content.

15. The method of claim 14, wherein the spam classification performing comprises applying one or more spam classifiers or statistical tools to the linked content to generate a spam confidence level.

16. The method of claim 15, wherein the determining comprises comparing the spam confidence level with a preset minimum confidence level and the storing comprises storing the spam confidence level.

17. The method of claim 12, wherein the determining comprises processing the URLs to generate a score and comparing the score to a preset minimum URL score and wherein the storing comprises storing the URL scores.
